(19) United States
(12) Patent Application Publication
(10) Pub. No.: US 2008/0017030 A1
(43) Pub. Date: Jan. 24, 2008

(54) Method And Filter Arrangement For Separating Exhaust Particulates

(76) Inventor: Carl Maria Fleck, Kaltenleutgeben (AT)

Correspondence Address: WILLIAM COLLARD;COLLARD & ROE, P.C., 1077 NORTHERN BOULEVARD, ROSLYN, NY, 11576, US

(21) Appl. No.: 11/667,247

(22) PCT Filed: Nov. 4, 2005
(86) PCT No.: PCT/AT05/00432

§ 371 Date: May 8, 2007

(30) Foreign Application Priority Data
Nov. 9, 2004 (AT) A 1866/2004

(51) Int. Cl. B03C 3/68; B03C 3/00

(52) U.S. Cl. 95/81; 96/24

(57) ABSTRACT

A method and apparatus for the operation of a filter arrangement for separating exhaust particulates from an exhaust gas stream, in which the exhaust gas stream is guided through ducts (20) of a ceramic body (1), which ducts extend in the longitudinal direction of a ceramic body (1) and are open on either side, and a voltage is applied to electrodes (5, 6) extending parallel to the ducts (20) in the ceramic body for generating an electric field in the ducts (20) of the ceramic body (1), which field is oriented transversally to the axis of the ducts (20), with a charging of the exhaust particulates occurring by means of a further electrode arrangement (29, 30) prior to the introduction of; the exhaust gas stream into the ducts (20) of the ceramic body (1). It is provided for in accordance with the invention that the voltage applied to the electrodes (5, 6) associated with the ceramic body (1) concerns unipolar voltage pulses which have a pulse duration of less then 20 μs each.

### BACKGROUND OF THE INVENTION

1. Field of the Invention

The invention relates to a method for the operation of a filter arrangement for separating exhaust particulates from an exhaust gas stream, in which the exhaust gas stream is guided through ducts of the ceramic body, which ducts extend in the longitudinal direction of the ceramic body and are open on either side, and a voltage is applied to electrodes extending parallel to the ducts in the ceramic body for generating an electric field in the ducts of the ceramic body, which field is oriented transversally to the axis of the ducts, with a charging of the exhaust particulates occurring by means of a further electrode arrangement prior to the introduction of the exhaust gas stream into the ducts of the ceramic body, in accordance with the preamble of claim 1.

The invention further relates to a filter arrangement for separating exhaust particulates from an exhaust gas stream, comprising a ceramic body with ducts which can be flowed through by exhaust gas, extend in the longitudinal direction of the ceramic body, are open on both sides and are separated from each other by webs, with electrodes being arranged on the ceramic body for generating an electric field in the ducts of the ceramic body, which field is oriented transversally to the axis of the ducts, and a further electrode arrangement for charging the exhaust particulates is arranged before the ceramic body as seen in the direction of flow of the exhaust gas, in accordance with the preamble of claim 8.

2. Prior Art

Methods and filter arrangements of this kind are known according to the state of the art. A method is described in EP 0 880 642 for example in which the exhaust particulates are separated by an electric direct-current voltage field after being charged in ducts which are open on both sides of a honeycomb body which is produced from a dense ceramic material and is continuously oxidized electrochemically by a gas plasma into carbon dioxide, with the gas plasma being excited by the separation field. Within the scope of this geometry of the ducts which are open on both sides, the direct-current voltage field is given the task on the one hand to ensure the separation of the exhaust particulates and on the other hand to cause the combustion of the separated particles. When the direct-current voltage field is sufficiently strong, not only the charged exhaust particulates are separated, but also the Richardson electrons emanating from every surface and at every temperature are accelerated towards the separated exhaust particulates. Since the probability of igniting an oxidation reaction by the impinging electrodes on the exhaust particulates increases with rising kinetic energy, it has been tried to choose the voltage at the outer electrodes of the honeycomb body as high as possible.

A stationary electric field, i.e. one that works with direct-current voltage, requires a strong limitation of the field strength on the honeycomb body because so-called “streamers” (pre-sparks) form both on the inlet part as well as the outlet part of the honeycomb body which usually concerns a monolith, which streamers lead to the triggering of sparks and thus not only impair the desired function of the honeycomb body, but also can subsequently lead to its destruction. In these transport processes of electric charges which precede each spark, the charge carriers form a slowly growing ion channel (“streamer”) which in its final stage “shorts” the electrodes. The electrode voltage is discharged via a high-energy plasma in a subsequent spark which might damage the thin webs between the ducts of the honeycomb body and prevent the formation of the electric field for separating the exhaust particulates.

Especially damaging has proved to be in this context the establishment of contact of the honeycomb body plus its feed line and switch capacities, because the spark cannot be extinguished prior to the discharge of all these capacities and the energy quantity is sufficiently high up to that point for damaging the honeycomb body.

It is known from EP 1 229 992 to generate an impulse field in the ducts of a honeycomb filter. It concerns a different kind of honeycomb filter here, in which the ducts are merely open on one side. Exhaust gas streaming through the same is thus forced to pass the porous intermediate walls between adjacent ducts, with exhaust particulates being separated in particular. The impulse field has the primary task of causing a massive emission and acceleration of electrons in the ducts of the honeycomb filter, which electrons subsequently cause an oxidation and conversion of the separated exhaust particulates. It is not the primary goal of this impulse field to ensure a separation of the exhaust particulates. The application and the configuration of the impulse field for the filter systems as described in EP 1 229 992 with ducts which are open on one side can thus not be applied to the application in accordance with the invention with ducts which are open on both sides.

It is therefore the object of the invention to prevent the formation of pre-sparks (“streamers”) by means of a suitable method and a new filter arrangement in order to thus prevent destructions of the ceramic body. This goal is achieved by the features of the claims 1 and 8.

### SUMMARY OF THE INVENTION

Claim 1 relates to a method for the operation of a filter arrangement for separating exhaust particulates from an exhaust gas stream, in which the exhaust gas stream is guided through channels of the ceramic body which extend in the longitudinal direction of the ceramic body and are open on both sides, and a voltage is applied on electrodes extending parallel to the ducts in the ceramic body for generating an electric field in the ducts of the ceramic body, which field is oriented transversally to the axis of the ducts, with a charging of the exhaust particulates occurring by means of a further electrode arrangement prior to the introduction of the exhaust gas stream into the ducts of the ceramic body. It is now provided for in accordance with the invention that the voltage applied to the electrodes associated with the ceramic body concerns unipolar voltage pulses which each have a pulse duration of less than 20 μs. By choosing unipolar voltage pulses for exciting the field strength in the ducts of the honeycomb body it is ensured that the ducts of the honeycomb structure act like a series connection of small capacitors which are charged in the same direction from the inside and release their charge only slowly by the collection of the charged exhaust particulates, the Richardson electrons and by the high-resistance conduction through the ceramic structure of the honeycomb body. As a result of this charging of the ducts, the desired separation field is obtained without there being any high voltage on the contacts of the honeycomb body or the feed line. Discharges occur at most within the individual ducts as discharges of the individual capacitors, which is a process which is unable to release any considerable energy amounts.

An exceptionally good control behaviour of this method in accordance with the invention is further obtained by charging the ducts with respect to combusting the exhaust particulate. Since the layer of exhaust particulate deposited in each duct represents a conductor which increases the capacity of the duct, a higher charging and thus a plasma current of longer duration is available for oxidation.

As a result of the charging of the ducts by means of the unipolar pulsed voltage in accordance with the invention a further advantage is obtained in that the effects of impairments in the ceramic structure of the honeycomb body such as damage to the webs between the ducts are lower with respect to the proper functioning of the filter arrangement because the behaviour of the ducts as a series connection of capacitors which is caused by the pulsed configuration of the voltage is more insensitive to structural imperfections in the honeycomb body.

According to claim 1, the pulses applied to the electrodes associated with the ceramic body each have a pulse duration of less than 20 μs, with the interval between two pulses each being at least 50 μs in accordance with claim 2. According to claim 3 the pulse duration is especially between 6 μs and 15 μs and the interval between two pulses is between 60 μs and 140 μs each.

It is especially advantageous for the method in accordance with the invention when according to claim 4 the voltage applied to the electrodes for charging the exhaust particulates also concerns unipolar voltage pulses. In the course of charging exhaust particulates, a similar problem may arise as in the separation of exhaust particulates. Aerosols such as exhaust particulates in an exhaust gas stream can be charged in a unipolar manner only with a respective direct current discharge in which therefore the discharge electrodes are arranged differently, so that a high field will build up on only one of the electrodes (hereinafter referred to as discharge electrode) which can initiate an impact ionization. The second electrode (hereinafter referred to as counter-electrode) is generally on earth potential and is formed by larger parts of the discharge chamber. The desired ion polarity is obtained in such a way that the gas multiplication occurs on the discharge electrode with the desired polarity and therefore the ions with the desired polarity are repelled from the same and need to pass through the discharge chamber to the electrode with the opposite polarity, with them charging the aerosol by deposition on their way there. If the aerosols concern exhaust particulates from diesel engines which are charged in a unipolar way and need to be separated by means of an electric direct-current field, one will encounter difficulties in realizing this arrangement. Supported by condensing water during cold starting, the exhaust particulates will deposit on the walls in the entire discharge chamber and especially soil the insulators of the voltage supply for such a time until a conductive coating forms on the same which triggers spark discharges which immobilize the discharge path. This occurs in such a way that the direct-current voltage at first triggers a slight leakage current in the exhaust particulate coating which leads to a heating of the conductive region in the exhaust particulate, thus reducing the electric resistance and increasing the current until the reached temperature triggers a strong spark.

According to claim 4, these disadvantages are prevented however in that the capacitance of the discharge electrode is charged by a unipolar pulse, said discharge electrode removes its charge and the field formed by said charge by forming a gas discharge and is charged again by the next unipolar pulse.

The voltage pulses applied to the electrodes for charging the exhaust particulates can be shaped differently than in the case of the electrodes of the ceramic body. Claim 4 for example provides a pulse duration of less than 20 μs each, with the interval between two pulses being at least 30 μs each. According to claim 5, the pulse duration is especially between 2 μs and 10 μs and the interval between two pulses is between 40 μs and 140 μs each.

The features of claim 6 have proven to be especially advantageous, according to which the application of voltage pulses to the electrodes associated with the ceramic body and the electrodes for charging the exhaust particulates occurs with the help of mutually independent control circuits. Different pulse duty factors of the voltage pulses can thus be realized. According to claim 7, the control of the voltage pulses is made on the basis of a signal which substantially has a value proportional to the concentration of the exhaust particulates in the exhaust gas stream and from which the feedback control of the electrode arrangement is derived for charging the exhaust particulates.

Claim 8 relates to a filter arrangement for separating exhaust particulates from an exhaust gas stream with a ceramic body comprising ducts which can be flowed through by the exhaust gas, extend in the longitudinal direction of the ceramic body, are open on both sides and are each separated from each other by webs, with electrodes being arranged on the ceramic body for generating an electric field in the ducts of the ceramic body, which field is oriented transversally to the axis of the ducts, and a further electrode arrangement for charging the exhaust particulates is arranged before the ceramic body as seen in the direction of flow of the exhaust gas. It is provided in accordance with the invention that one of the electrodes associated with the ceramic body is connected with a voltage source for generating unipolar voltage pulses and the capacitance C of the ducts of the ceramic body, and the direct voltage U induced in said capacitance by the unipolar pulse peak U₀, the thus triggered plasma currents i and the interval τ of the unipolar pulses fulfil the following relationship:
UC/i≧τ
and the ohmic resistance R of the webs of the ceramic body are chosen in such a way that the capacitance C of the ducts of the ceramic body and the plasma current i triggered by the direct voltage U in the ducts fulfil the following relationship:
UC/i₀≧UC/i
with
Ri₀=U
so that
RC≧UC/i bzw. iR≧U.

As a result of such an instrumental implementation of a filter, it is ensured that the charge carriers are able to distribute again in the semi-finished ion channels by diffusion and turbulence and in addition are flushed away by the exhaust gas flow from the respective inlet surface.

In accordance with claim 9, the effective overall resistance of the ceramic body is between 100 kOhm and 10 MOhm with respect to the electrodes associated with the same. In this way, the ducts of the honeycomb body and optionally their covering with exhaust particulates represent in an especially effective way a series connection of themselves with respect to the electric contacting of the honeycomb body by the capacitances which are charged by the voltage pulse.

Claim 10 relates to the electrode arrangement for charging the exhaust particulates and provides that it comprises a discharge electrode and a counter-electrode, with the discharge electrode being connected with a voltage source for generating unipolar -voltage pulses and the counter-electrode consisting of an insulator, preferably one made of ceramic material, having a volume resistance of 100 kΩcm² to 500 kΩcm². It is provided for according to claim 11 that the side of the counter-electrode averted from the discharge electrode is electrically contacted and is connected with ground, and the side facing the discharge electrode has a surface resistance of 10 ⁴ Ωcm to 10⁸ Ωcm, preferably between 10⁵ Ωcm to 10₇ Ωcm. Claim 12 provides that the counter-electrode is provided on its side facing the discharge electrode with a coating made of A₁₂O₃, TiO, ZrO, CrO or mixtures thereof.

According to claim 13, two mutually independent circuits are provided for differently charging the electrodes associated with the ceramic body and the electrodes for charging the exhaust particulates with voltage pulses. It is thus possible again to realize different pulse duty factors of the voltage pulses.

Claim 14 finally provides that a ceramic insulation is provided as a carrier for the discharge electrode and the capacitance C of the discharge path between the discharge electrode and the counter-electrode, the direct voltage U induced in said capacitance by the unipolar pulse peak U₀, the thus triggered discharge currents i and the interval τ of the unipolar pulses fulfil the following relationship:
UC/i≧τ
with the ohmic resistance R of the ceramic insulation being chosen in such a way that the capacitance C of the discharge path and the discharge current i triggered by the direct voltage U at the discharge electrode fulfil the following relationship:
UC/i₀≧UC/i
with
Ri₀=U
so that
RC≧UC/i bzw. iR≧U
applies. In a filter arrangement of this kind, the above difficulties are avoided very effectively. In particular, the very short charge peak and the subsequently occurring slow drop of the voltage in the ducts which now act like capacitors with respect to their electric properties prevent the formation of the heating current paths in the exhaust particulate and the thus triggered leakage currents. The energy density of the gas discharge at the discharge electrode can be set considerably higher without causing any misoperation of the discharge electrode.

### BRIEF DESCRIPTION OF THE DRAWING

The invention is now explained in closer detail by reference to the enclosed drawings, wherein:

FIG. 1 shows a longitudinal sectional view through a possible embodiment of a ceramic body with upstream apparatus for charging exhaust particulates in the exhaust gas stream;

FIG. 2 shows a diagram for charging the electrodes associated with the ceramic body with unipolar voltage pulses;

FIG. 3 shows a diagram for charging the discharge electrode with unipolar voltage pulses for charging the exhaust particulates;

FIG. 4a shows a representation of the voltage conditions in the ducts of the ceramic body which act like capacitors when the electrodes associated with the ceramic body are charged with voltage pulses, and

FIG. 4b shows a representation of the voltage conditions between discharge electrode and counter-electrode of the electrode arrangement for charging the exhaust particulates when the discharge electrode is charged with voltage pulses.

### DETAILED DESCRIPTION OF THE INVENTION

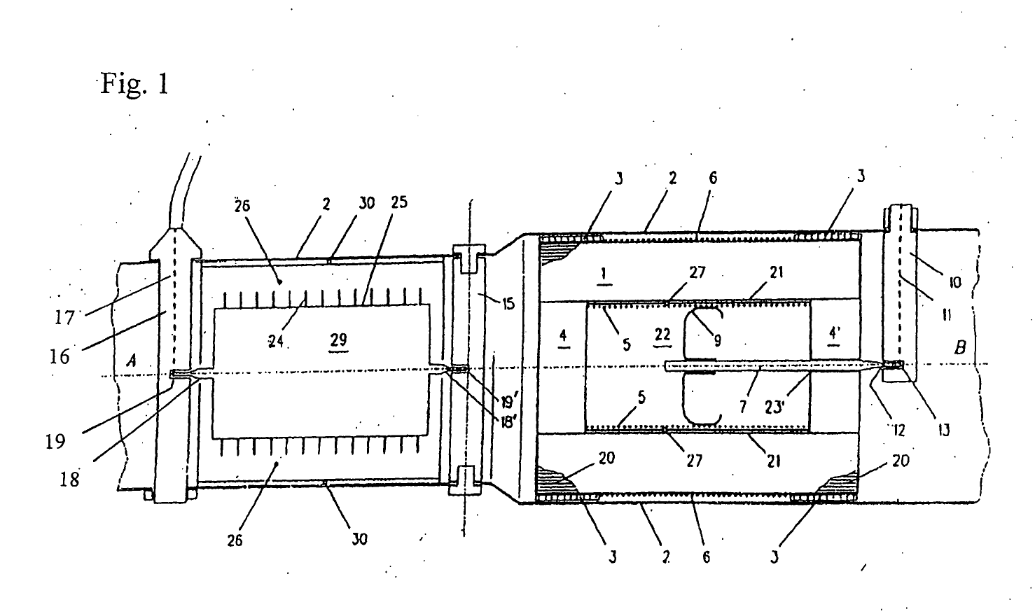

A possible embodiment of a ceramic body with upstream apparatus for charging exhaust particulates in an exhaust gas stream will be explained for better illustration of the invention by reference to FIG. 1. A ceramic body 1 of annular cross section is fastened by press mats, wire meshes 3 or the like in a cylindrical pipe 2 made of metal. The hollow inside part 22 of the ceramic body 1 is sealed on the inlet side with a non-conductive, preferably ceramic plug 4. An electrically conductive layer is arranged on the inner and outside cylinder jacket of the ceramic body 1, which layer is used as an inner electrode 5 connected to high voltage or as an outer electrode 6 connected to ground. The hollow cavity 22 of the ceramic body 1 is sealed on the outlet side by a non-conductive, preferably ceramic plug 4′. The plug 4′ comprises a thin bore, through which metallic pipe 7 with the thinnest possible diameter is guided, which pipe establishes the contact of the inner electrode 5 with the help of a contact spring 9. The high voltage is supplied to the pipe 7 by a conductor 11 arranged in a ceramic cylindrical support 10. The end of the pipe 7 on the rear side tapers into a pin 12 which is electrically connected with the conductor 11 and engages in a recess 13 of the support 10. The discharge electrode 29 is arranged in the pipe 2 of the exhaust train, electrically and mechanically separated from the ceramic body 1. The discharge electrode 29 comprises a ceramic insulation 25 as a carrier for electron-emitting corona teeth 24 and thin pins 18, 18′ on both sides, preferably with a thickness of 2 to 4 mm, through which the discharge electrode 29 is supported in ceramic carriers 15, 16. The high voltage is supplied to the discharge electrode 29 via a conductor 17 guided in carrier 16 via the pin 18. The counter-electrode 30 encompassing the discharge electrode 29 is formed by a ceramic coating attached to pipe 2 which has a thickness of 0.1 to 0.5 mm, and comprises an electric volume resistance relating to cm² of 1 MΩcm² to 1 GΩcm², preferably 10 MΩcm².

A PTC resistor 27 is arranged between the inner electrode 5 and the inside wall 21 of the ceramic body 1, which resistor increases its resistance upon increase of the temperature. The PTC resistor 27 compensates with the rise in its resistance the resistance of the ceramic body 1 which decreases at higher temperatures.

The exhaust gas entering at A is ionized during its crossing of the discharge path 26 between the discharge electrode 29 and the counter-electrode 30, subsequently flows through the ducts 20 of the ceramic body 1 and leaves the exhaust filter at B. As a result of the electric field established between the inner electrode 5 and the outer electrode 6, a deposition of the exhaust particulates contained in the exhaust gas occurs on the side walls of the ducts 20. As a result of the temperature, electrons leak from the walls of ducts 20, which electrons are accelerated by the electric field prevailing there in the direction towards the exhaust particulate depositions and initiate an oxidation of the exhaust particulates upon impact.

As already mentioned, a stationary electric field, which thus works with direct voltage, requires a strong delimitation of the field strength on the honeycomb body 1 because so-called “streamers” (pre-sparks) form both in the inlet portion as well as the outlet portion of the monolith, which streamers lead to the triggering of sparks and not only impair the desired function of the honeycomb body 1 but subsequently can also lead to the destruction of the same.

Measurements on different honeycomb bodies 1 have shown that for the formation of “streamers” on the strongly sooted inlet surface of the monolith at least 20 μs are necessary so that sufficient charge carriers can “flow into” the ion channel in order to ignite the spark. That is why a method and an apparatus were developed in accordance with the invention in which unipolar HF pulses are supplied to the honeycomb body 1. The honeycomb body 1, which comprises open ducts 20, can be electrically contacted on two diametrically opposite sides and parallel to the ducts 20, which occurs in a honeycomb body 1 preferably in form of an annular cylinder on the inner and outer jacket surface. The effective total resistance of the honeycomb body 1 with respect to its electric contacting lies preferably between 100 kΩ and 10 MΩ, so that the ducts 20 of the honeycomb body 1 and optionally their coating with exhaust particulate represent a series connection of capacitances charged by the pulse with respect to the electric contacting of the honeycomb body 1. The unipolar HF pulses can be injected with a pulse duration of less than 20 μs, preferably between 6 μs and 15 μs, into the honeycomb body 1 via said contacting, with said pulse being repeated at the earliest after 50 μs, preferably after 60 μs to 140 μs. This results in a repetition frequency of 7 kHz to 17 kHz. Generally, the repetition frequencies can lie in the range of between 1 kHz and 100 kHz. The direct current share of the electric field can be set in the honeycomb body 1 by changing the repetition frequency. The unipolar HF pulses can be controlled with respect to their level by a signal which has a value which is substantially proportional to the concentration of the exhaust particulates and is preferably obtained from the regulation of the discharge path which ensures the charging of the exhaust particulates. This concerns negative voltage pulses here which depend on the coating with exhaust particulates, the temperature and the combustion.

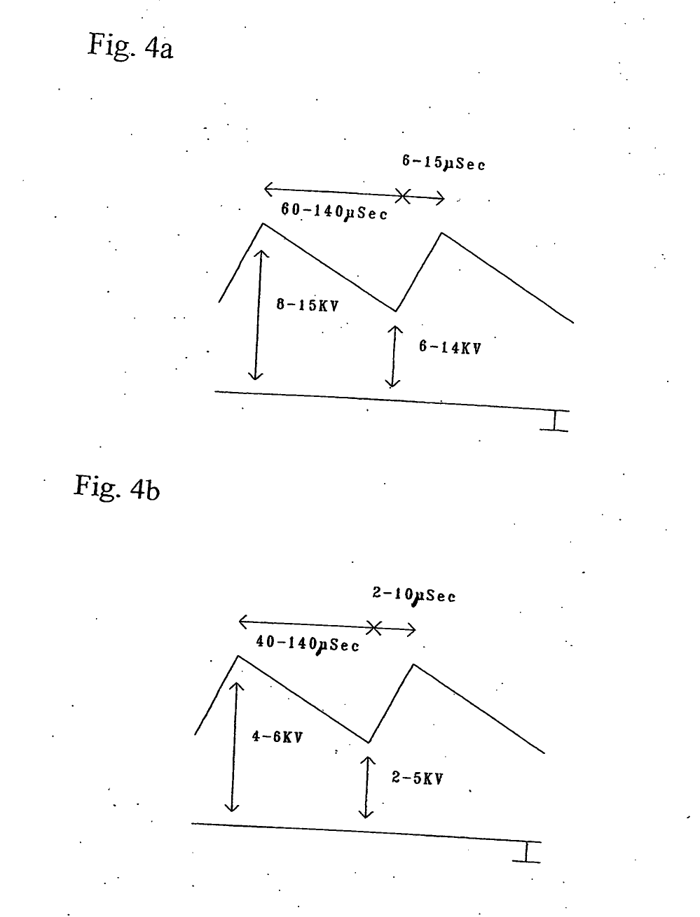

FIG. 4a shows an illustration of the voltage conditions in the ducts 20 of the ceramic body 1 which follow from an pulse charging of this kind. Typical values are for example 8 kV to 15 kV for the voltage peaks of the charging and 6 kV to 14 kV for the voltage minima. The voltage minima are low enough in order to suppress the formation of sparks, with exhaust particulate combustion also occurring during the voltage minima.

The above measures ensure that the individual ducts 20 of the honeycomb body 1 act like a series connection of capacitances with respect to the outer contacting 5, 6 of the ceramic body 1 (more precisely like a network of capacitances connected in parallel and serially), i.e. they will charge up by the unipolar pulse and emit their charge only slowly by the collection of the charged exhaust particulates, the Richardson electrons and by the high-resistance conduction through the ceramic structure of the honeycomb body 1.

It has been seen further that it is necessary to wait at least 60 μs to 80 μs so that the charge carriers in the semi-finished ion channels can evenly distribute again by diffusion and turbulence and are flushed away from the respective inlet surface by the gas stream.

Furthermore, an exceptionally good control behaviour of this method in accordance with the invention was seen with respect to the combustion of the exhaust particulate by the charging of the ducts 20. Since the layer of exhaust particulate deposited in each duct 20 represents a conductor which increases the capacitance of the duct 20, a higher charging and thus a plasma current of longer duration is available for oxidation.

The quantitative correlations of this procedure in accordance with the invention are characterized especially in such a way that the capacitance C of the ducts 20 of the ceramic body 1, the direct voltage U induced in said capacitance by the unipolar pulse peak U₀, the thus triggered plasma currents i and the interval τ of the unipolar pulses fulfil the following relationship:
UC/i≧τ
and the ohmic resistance R of the webs of the ceramic body 1 are chosen in such a way that the capacitance C of the ducts 20 of the ceramic body 1 and the plasma current i triggered by the direct voltage U in the ducts 20 fulfil the following relationship:
UC/i₀≧UC/i
with
Ri₀=U
so that
RC≧UC/i bzw. iR≧U
applies. The Parameter i₀ stands for the plasma currents generated by a voltage U₀. A pulse charging conducted under these boundary conditions has further decisive advantages over the stationary charging. As a result of the reduced inclination towards the formation of “streamers”, the individual channels 20 can not only be charged higher, but local “streamers” can be discharged locally without causing any extended arc-throughs of larger areas. The energy released in such a discharge remains low and is unable to damage the ceramic structures.

A further advantage of pulse charging lies in the highly reduced susceptibility to leakage currents inside and outside the monolith, since in this case too the formation of current paths via the exhaust particulate or through discontinuities of the ceramic leadthroughs require similar times for their formation like the “streamers” themselves.

Substantial advantages were further noticed in dynamic driving operations when in accordance with the invention the unipolar HF pulses are controlled with respect to their level by a signal which substantially has a value which is proportional to the concentration of the exhaust particulates and which is preferably obtained from the control of the discharge path 26 which ensures the charging of the exhaust particulates. The correlation is obtained from the screening of the electric fields by a high concentration of electric charges which, when bound to the exhaust particulates, have only low mobility and generate a quasi static space charge.

It is especially advantageous for the method in accordance with the invention or the filter arrangement in accordance with the invention when the voltage applied to the electrodes 29, 30 for charging the exhaust particulates also concerns a pulsed unipolar voltage.

As already mentioned above, a direct voltage applied to one of the electrodes 29, 30 can cause a slight leakage current in the exhaust particulate coating at first, which current leads to a heating of the conductive area in the exhaust particulate, which thus reduces the electric resistance and increases the current until the reached temperature triggers a strong spark. According to the state of the art, there are arrangements and methods to quench these spark discharges. However, sparks from direct voltage discharges lead to the consequence from the capacitances connected with the same that said sparks release relatively high amounts of energy until their quenching, which amounts of energy lead to a heating of the starting points of these sparks (spark basis). If the direct voltage is activated again after the performed quenching, the residual heat present at the spark basis is sufficient for immediately triggering new sparks and the discharge path needs to be deactivated again immediately. This is compounded by a further disadvantage: If these exhaust particulates are to be separated for reducing emissions of diesel motor vehicles, the sparks prevent the application of this method in the car industry by strongly releasing nitrogen oxides.

In accordance with the invention, all these disadvantages can be avoided by a method and an apparatus in which the capacitance of the discharge electrode 29 is charged by a unipolar pulse, said discharge electrode 29, by forming a gas discharge, reduces its charge and the field formed by said charge, and thereafter is charged again by the next unipolar pulse.

The electrode arrangement for charging the exhaust particulates can be arranged advantageously in such a way that it comprises a discharge electrode 29 and a counter-electrode 30, with the discharge electrode 29 being connected with a voltage source for generating unipolar voltage pulses and the counter-electrode 30 consists of an insulator, preferably a ceramic, having a volume resistance of 100 kΩcm² to 500 kΩcm². The side of the counter-electrode 30 averted from the discharge electrode 29 is electrically contacted and connected with ground, and the side of the discharge electrode 29 facing the discharge electrode 29 has a surface resistance of 10⁴ Ωcm to 10⁸ Ωcm for example, preferably between 10⁵ Ωcm to 10⁷ Ωcm. Furthermore, the counter-electrode 30 can be provided on its side facing the discharge electrode 29 with a coating, made for example of A₁₂O₃, TiO, ZrO, CrO or mixtures thereof.

The pulse voltage can be dimensioned depending on the temperature of the exhaust gas with approximately 8 kV to 18 kV of pulse overshoot per cm of electrode distance. The distance between tip 24 and counter-electrode 30 can be between 5 mm and 10 mm, thus leading to a preferred pulse voltage of between 4 kV and 18 kV. Discharge electrode 29 can comprise at least 200, preferably 300 electrode tips 24 whose minimal distance from each other is larger than the electrode distance and corresponds approximately to the length of the tips 24. The arrangement of adjacent electrode tips 24 can be mutually offset in the direction of the flow and preferably correspond to an equilateral triangle. The arrangement of the discharge electrode 29 with the tips 24 and the opposite smooth counter-electrode 30 is preferably cylindrical and concentric, with the smooth counter-electrode 30 enclosing the discharge electrode 29 as a concentric tube and being electrically contacted on its outside.

The method in accordance with the invention and the apparatus in accordance with the invention will work in an optimal manner when the electronic parameters have been chosen in such a way that the discharge electrode 29 is charged by very short unipolar pulses whose duration lies under 20 μs, preferably between 2 μs and 10 μs, and whose pulse interval to the next unipolar pulse is at least 30 μs, preferably between 40 μs and 140 μs. These concern negative voltage pulses whose choice depends on the temperature and the exhaust gas composition. The duration and intervals of the voltage pulses can be controlled by a microprocessor for example whose operating programme corrects both an overload of the electronic system as well as sparkovers.

FIG. 4b shows a representation of the voltage conditions between discharge electrode 29 and the counter-electrode 30 of the electrode arrangement for charging the exhaust particulates when the discharge electrode 29 is charged with voltage pulses. Voltage minima in the range of 2 kV to 5 kV and voltage maxima in the range of 4 kV to 6 kV have proven to be advantageous.

The charge current can be limited with a predetermined value, such that the amount of the voltage of the unipolar pulse can be returned. Furthermore, the maximum value which is predetermined for the charge current can be increased in steps, such that the amount of the associated voltage of the unipolar pulse is also returned in steps.

The correlations underlying the invention are characterized especially in such a way that the capacitance C of the discharge path 26 between the discharge electrode 29 and the counter-electrode 30, the direct voltage U induced in said capacitance by the unipolar pulse peak U₀, the thus triggered discharge currents i and the interval τ of the unipolar pulses fulfil the following relationship:
UC/i≧τ
with the ohmic resistance R of the ceramic insulation of the discharge electrode 29 being chosen in such a way that the capacitance C of the discharge path 26 and the discharge current i triggered by the direct voltage U at the discharge electrode 39 fulfil the following relationship:
UC/i₀≧UC/i
with
Ri₀=U
so that
RC≧UC/i bzw. iR≧U
applies. The parameter i₀ stands for the plasma currents generated by a voltage U₀. The difficulties as explained above can thus be prevented in a very effective manner. In particular, the short charge peak and the subsequent slow drop in the voltage between discharge electrode 29 and the counter-electrode 30 seem to prevent the formation of the heating current paths in the exhaust particulate and the thus triggered leakage currents. The energy density of the gas discharge at the discharge electrode 29 can be set in a considerably higher way without causing any misoperation in the discharge electrode 29.

It has proven to be especially effective as a further measure for damping the spark energy when the counter-electrode 30 which is opposite of the discharge electrode 29 has a high electric volume resistance, but which, unlike a barrier discharge, allows a continuity which depending on the temperature and the current intensity causes in the counter-electrode 30 a voltage drop of a few 50 V to a few 500 V.

As a result, a few 50 V to a few 500 V will drop in accordance with the invention on the counter-electrode 30 which preferably consists of a ceramic material with a defined resistance, and the cloud of electrons which is released in a pulse-like manner moves with decreasing speed to the charging counter-electrode 30. The electrons remain longer in the gas chamber, attach themselves to more oxygen molecules and thus also contribute to a higher charging of the exhaust particulates with charged oxygen. This is especially advantageous when an increasingly stronger reduction of the nitrogen oxides (Nox) by an increasingly higher set exhaust gas recirculation (“super EGR”) leads to a strong reduction in the residual oxygen and the exhaust particulates need the attached oxygen in order to enable combustion.

Said charging of the exhaust particulate not only has an advantageous effect on a regeneration by electric plasma, in the case of a thermally induced regeneration with the help of a catalyst it also substantially lowers the then necessary temperature for the initiation of the oxidation in accordance with the invention. If a catalytically coated exhaust particulate filter is able at a high content of oxygen in the exhaust gas (i.e. without EGR) to oxidize the exhaust particulate already at 400° C., it needs approximately 450° C. with currently available EGR and already 500° C. in engines with “super EGR” currently running on the test stands of the automotive industry.

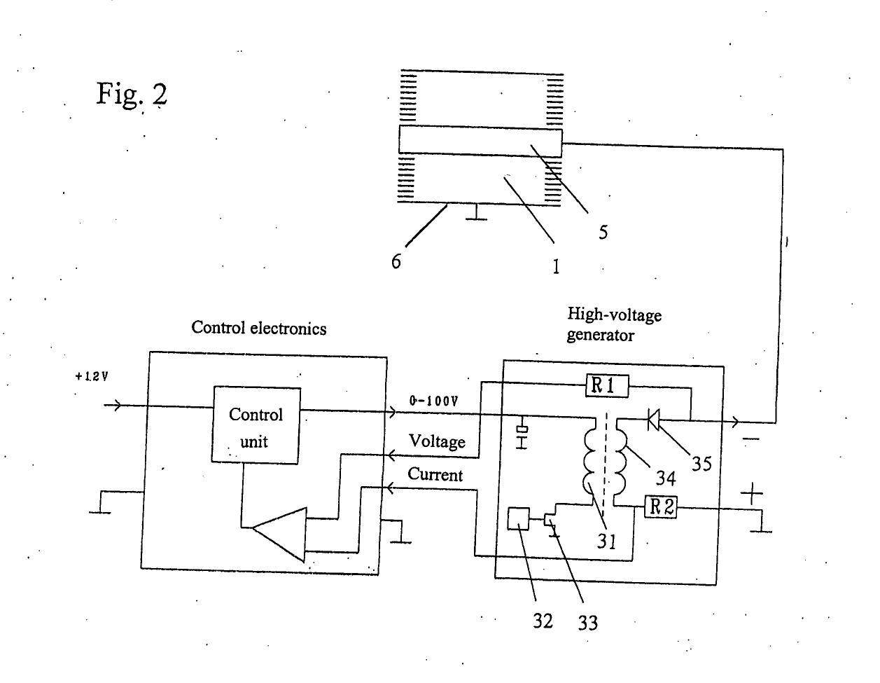

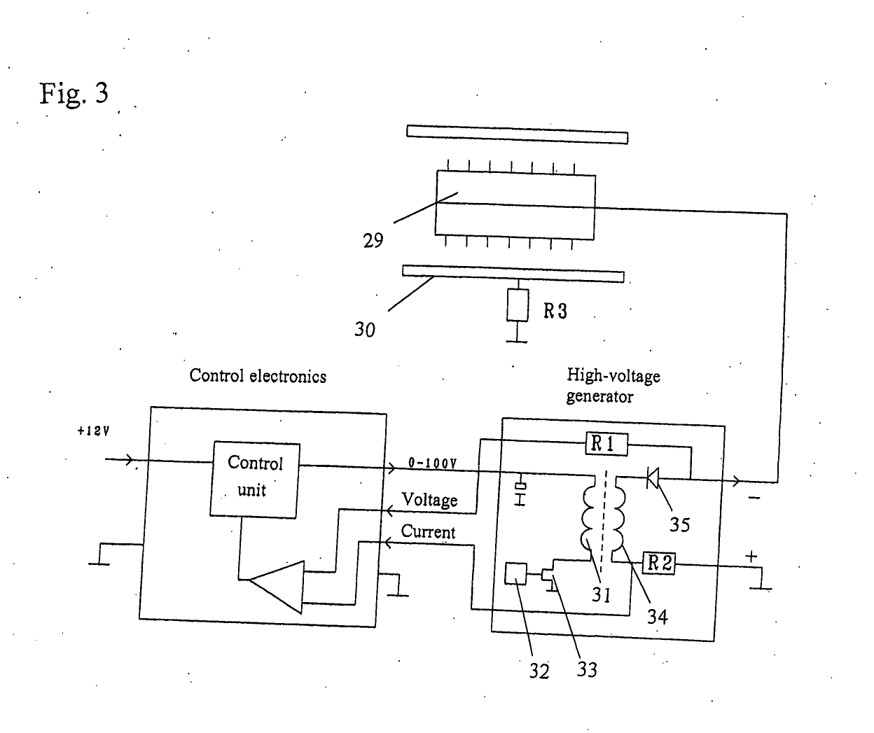

FIG. 2 shows an embodiment in accordance with the invention of the electronic circuit with which unipolar high-voltage pulses can be generated and can be supplied to the electrode 5 associated with ceramic body 1. FIG. 3 accordingly shows an embodiment in accordance with the invention of the electronic circuit with which unipolar high-voltage pulses can be generated and can be supplied to the discharge electrode 29. The electronic control system generates a controlled supply voltage for the primary side 31 ferrite core transformer from the supply voltage of the motor vehicle and with the help of the control signal for the pulse voltage which is tapped via resistor R1 and from the control signal for pulse current which is tapped via resistor R2, which transformer supplies the primary side 31 of the ferrite core transformer with respectively fast-rising voltage pulses via an electronic switch 33, preferably a field effect transistor, triggered by a processor 32. The outputs of the secondary side 34 of the ferrite core transformer are supplied on the one hand via the high-voltage diode 35 to the discharge electrode 29 and are grounded on the other hand via the resistor R2. In this way, the negative part of the high-voltage pulse can reach the discharge electrode 29, while the positive part is discharged to ground or is supplied to a respective control signal for the pulse current. The high electric resistance of the counter-electrode 30 is reflected in the circuit by the resistor R3. This method was implemented by circuitry in such a way that the unipolar HF-pulses were achieved by a series connection consisting of a ferrite core transformer and a high-voltage diode 35, and the energy of the second pulse share contained in the transformer is guided back to a capacitor and thus remains for the primary triggering of the ferrite core transformer. The ferrite core transformer with integrated high-voltage diode 35 can be placed directly on the pulse leadthrough of the filter housing. The charging of the electrodes 5, 6 and the electrodes 29, 30 associated with the ceramic body preferably occurs for charging the exhaust particulates with voltage pulses with the help of mutually independent control circuits such as are shown for example in FIGS. 2 and 3.

The method in accordance with the invention and the filter arrangement in accordance with the invention can thus be used to prevent the formation of pre-sparks (“streamers”) and thus destructions of the ceramic body 1.

1. A method for the operation of a filter arrangement for separating exhaust particulates from an exhaust gas stream, in which the exhaust gas stream is guided through ducts of a ceramic body, which ducts extend in the longitudinal direction of a ceramic body and are open on either side, and a voltage is applied to electrodes extending parallel to said ducts in said ceramic body for generating an electric field in said ducts of said ceramic body which is each oriented transversally to the axis of said ducts, with a charging of the exhaust particulates occurring by means of a further electrode arrangement prior to the introduction of the exhaust gas stream into said ducts of said ceramic body, characterized in that the voltage applied to said electrodes associated with the ceramic body concerns unipolar voltage pulses which have a pulse duration of less than 20 μs each.

2. A method according to claim 1, characterized in that the interval between two pulses is at least 50 μs each.

3. A method according to claim 2, characterized in that the pulse duration is between 6 μs and 15 μs and the interval between two pulses is between 60 μs and 140 μs each.

4. A method according to claim 1, characterized in that the voltage applied to said electrodes for charging the exhaust particulates concerns unipolar voltage pulses which have a pulse duration of less than 20 μs each and the interval between two pulses is at least 30 μs each.

5. A method according to claim 4, characterized in that the pulse duration is between 2 μs and 10 μs and the interval between two pulses is between 40 μs and 140 μs each.

6. A method according to claim 1, characterized in that the application of said voltage pulses to said electrodes associated with the ceramic body and said electrodes for charging the exhaust particulates occurs with the help of mutually independent control circuits.

7. A method according to claim 6, characterized in that the control of said voltage pulses is made on the basis of a signal which substantially has a value proportional to the concentration of the exhaust particulates in the exhaust gas stream and from which the feedback control of said electrode arrangement is derived for charging the exhaust particulates.

8. A filter arrangement for separating exhaust particulates from an exhaust gas stream, comprising a ceramic body with ducts which can be flowed through by exhaust gas, extend in the longitudinal direction of the ceramic body, are open on both sides and are separated from each other by webs, with electrodes being arranged on said ceramic body for generating an electric field in said ducts of said ceramic body, which field is oriented transversally to the axis of said ducts, and a further electrode arrangement for charging the exhaust particulates is arranged before said ceramic body as seen in the direction of flow of the exhaust gas, characterized in that one of said electrodes associated with said ceramic body is connected with a voltage source for generating unipolar voltage pulses, and the capacitance C of said ducts of said ceramic body, and the direct voltage U induced in said capacitance by the unipolar pulse peak U₀, the thus triggered plasma currents i and the interval τ of said unipolar pulses fulfil the following relationship:
UC/i≧τ
and the ohmic resistance R of said webs of said ceramic body are chosen in such a way that the capacitance C of said ducts of said ceramic body and the plasma current i triggered by the direct voltage U in said ducts fulfil the following relationship:
UC/i₀≧UC/i
with
Ri₀=U
so that
RC≧UC/i or iR≧U.

9. A filter arrangement according to claim 8, characterized in that the effective overall resistance of said ceramic body is between 100 kiloohms and 10 megohms with respect to said electrodes associated with the same.

10. A filter arrangement according to claim 8, characterized in that said electrode arrangement for charging the exhaust particulates comprises a discharge electrode and a counter-electrode, with said discharge electrode being connected with a voltage source for generating said unipolar voltage pulses and said counter-electrode consisting of an insulator, preferably one made of ceramic material, having a volume resistance of 100 kΩcm² to 500 kΩcm².

11. A filter arrangement according to claim 10, characterized in that the side of said counter-electrode averted from said discharge electrode is electrically contacted and is connected with ground, and the side facing said discharge electrode has a surface resistance of 10⁴ Ωcm to 10⁸ Ωcm, preferably between 10⁵ Ωcm to 10⁷ Ωcm.

12. A filter arrangement according to claim 10, characterized in that said counter-electrode is provided on its side facing said discharge electrode with a coating made of A₁₂O₃, TiO, ZrO, CrO or mixtures thereof.

13. A filter arrangement according to claim 10, characterized in that two mutually independent circuits are provided for differently charging said electrodes associated with said ceramic body and said electrodes for charging the exhaust particulates with voltage pulses.

14. A filter arrangement according to claim 10, characterized in that a ceramic insulation is provided as a carrier for said discharge electrode, and the capacitance C of the discharge path between said discharge electrode and said counter-electrode, the direct voltage U induced in said capacitance by the unipolar pulse peak U₀, the thus triggered discharge currents i and the interval τ of said unipolar pulses fulfil the following relationship:
UC/i≧τ
with the ohmic resistance R of said ceramic insulation being chosen in such a way that the capacitance C of the discharge path and the discharge current i triggered by the direct voltage U at said discharge electrode fulfil the following relationship:
UC/i₀≧UC/i
with
Ri₀=U
so that
RC≧UC/i or iR≧U.
